(19) United States
(12) Patent Application Publication
(10) Pub. No.: US 2012/0048655 A1
(43) Pub. Date: Mar. 1, 2012

(54) METHOD FOR CONTROLLING ELEVATORS OF MULTI-STOREY BUILDING BY UTILIZING MOBILE PHONE

(75) Inventor: Feng-Wei HSU, Taipei (TW)

(73) Assignee: INVENTEC CORPORATION, Taipei (TW)

(21) Appl. No.: 12/965,062

(22) Filed: Dec. 10, 2010

(30) Foreign Application Priority Data
Aug. 30, 2010 (CN) 201010269627.9
Sep. 3, 2010 (CN) 201010274527.5

(51) Int. Cl. B66B 1/14

(52) U.S. Cl. 187/247

(57) ABSTRACT

A method for controlling elevators of a multi-storey building by utilizing a mobile phone is provided. The method includes the following steps. A current storey is detected by a mobile phone. Elevator motion information is obtained via an intra-building broadcasting system. The mobile phone logs in to an elevator control system. An elevator that can arrive at the current storey of the mobile phone is selected according to the motion information. An elevator selection message is transmitted to the elevator control system by the mobile phone for controlling the selected elevator to move to the current storey of the mobile phone.

This application claims the benefit of People's Republic of China application Serial No. 201010269627.9, filed Aug. 30, 2010, and People's Republic of China application Serial No. 201010274527.5, filed Sep. 3, 2010, the subject matter of which is incorporated herein by reference.

### BACKGROUND OF THE INVENTION

1. Field of the Invention

The invention relates in general to a method for controlling the elevators of a multi-storey building by utilizing a mobile phone, and more particularly to a highly convenient method for controlling the elevators of a multi-storey building by utilizing a mobile phone.

2. Description of the Related Art

As the multi-storey buildings are getting higher and higher, elevators are getting more popular and more popular. Many people need to use elevators quite often in their everyday life. However, bad luck comes, people may spend considerable time waiting for the elevator, and this is indeed a waste of time. Therefore, how to help people to reduce the elevator waiting time is conducive to efficiency and time management.

### SUMMARY OF THE INVENTION

The invention is directed to a method for controlling the elevators of a multi-storey building by utilizing a mobile phone. Through the use of mobile phone, the user instantly obtains the elevator motion information for saving elevator waiting time.

According to a first aspect of the present invention, a method for controlling elevators of a multi-storey building by utilizing a mobile phone is provided. The method includes the following steps. A current storey is detected by a mobile phone. Elevator motion information is obtained via an intra-building broadcasting system. The mobile phone logs in to an elevator control system. An elevator that can arrive at the current storey of the mobile phone is selected according to the motion information. An elevator selection message is transmitted to the elevator control system by the mobile phone for controlling the selected elevator to move to the current storey of the mobile phone.

According to a second aspect of the present invention, a method for displaying elevator state of multi-storey building by using a mobile phone is provide. The method includes the following steps. A current storey is detected by a mobile phone. Elevator motion information is obtained via an intra-building broadcasting system. The elevator motion information is displayed on the mobile phone screen.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of an example of a method for controlling the elevators of a multi-storey building by utilizing a mobile phone according to a preferred embodiment of the invention;

FIG. 2 shows motion information illustrated in drawings according to a preferred embodiment of the invention;

FIG. 3 shows a flowchart of another example of a method for controlling the elevators of a multi-storey building by utilizing a mobile phone according to a preferred embodiment of the invention; and

FIG. 4 shows detailed flowchart of another example of a method for controlling the elevators of a multi-storey building by utilizing a mobile phone according to a preferred embodiment of the invention.

### DETAILED DESCRIPTION OF THE INVENTION

The invention provides a method for controlling the elevators of a multi-storey building by utilizing a mobile phone. Through the use of mobile phone, the user instantly obtains the elevator motion information and logs in to the elevator control system for saving elevator waiting time.

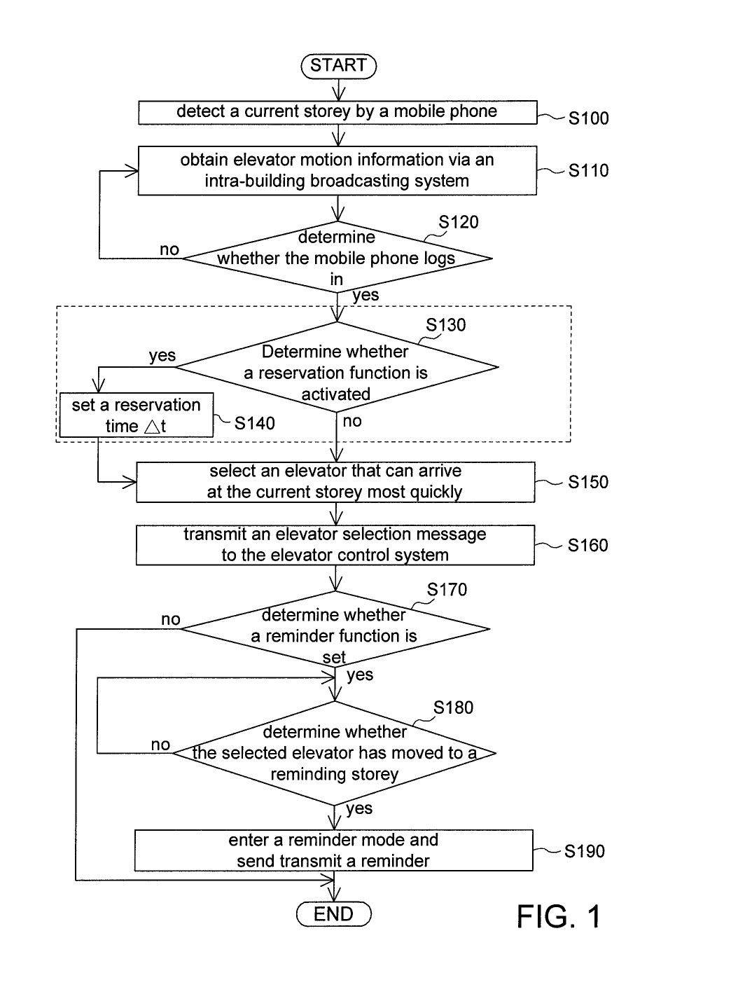

Referring to FIG. 1, a flowchart of an example of a method for controlling the elevators of a multi-storey building by utilizing a mobile phone according to a preferred embodiment of the invention is shown. The method for controlling the elevators of a multi-storey building by utilizing a mobile phone disclosed in the present embodiment of the invention can be implemented by installing software in the mobile phone, but the invention is not limited thereto. In step S100, the current storey is detected by a mobile phone, which can recognize the current storey of the mobile phone from the media access control (MAC) address of a Wifi station (AP). In step S110, the current motion information of the elevators of a multi-storey building is obtained by the mobile phone via an intra-building broadcasting system, wherein the intra-building broadcasting system is such as a wireless local area network (wireless LAN), a general packet radio service (GPRS), a 3rd-generation (3G) or a 4th-generation (4G).

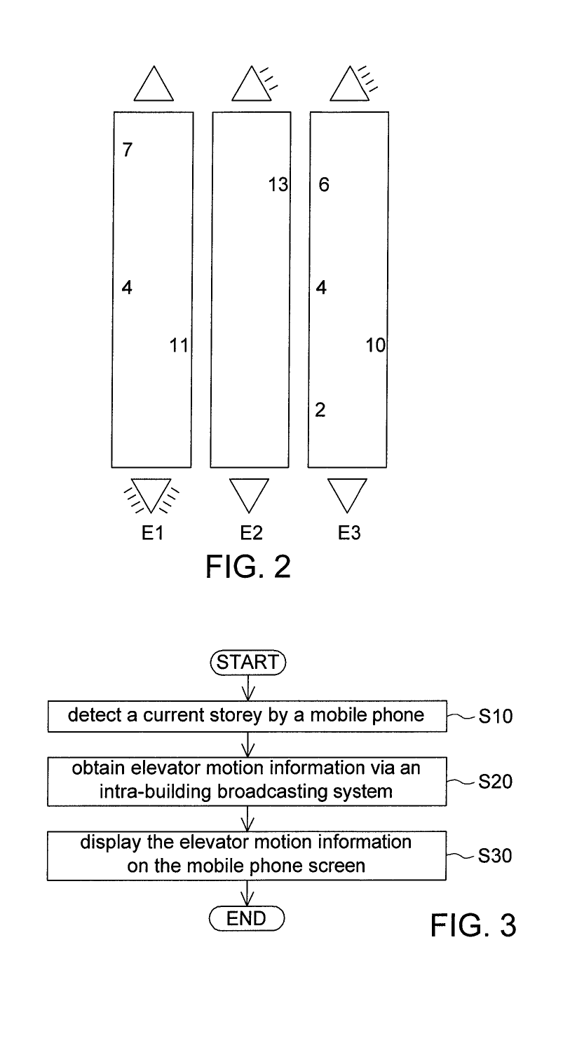

The elevator motion information includes information such as the current storey and the queue state of respective elevators, and can be illustrated in drawings and displayed on the mobile phone screen as indicated in FIG. 2. In FIG. 2, the state of elevator E1 can be illustrated by a downward elevator which will stop at storey 11, storey 7 and storey 4. The state of elevator E2 can be illustrated by an upward elevator which will stop at storey 13. The state of elevator E3 can be illustrated by an upward elevator which will stop at storey 2, storey 4, storey 6 and storey 10. The elevator motion information is collected and updated by an elevator control system of a multi-storey building, which further broadcasts the elevator motion information to the mobile phones which would like to receive the motion information via the intra-building broadcasting system at a fixed time interval.

In step S120, whether the mobile phone logs in to an elevator control system is determined. If the user wants to know the elevator motion information only but does not want to use the elevator, then the method returns to step S110. If the mobile phone logs in to an elevator control system, then the method proceeds to step S130, whether a reservation function is activated is determined. If the reservation function is not activated, then the method proceeds to step S150, the state of the elevators are determined according to the motion information, and the elevator that can most quickly arrive at the current storey is selected by the mobile phone. If the user may use the elevator in 10 minutes, then the reservation function can be activated in step S130, so that in step S140, the mobile phone will wait for a reservation time Δt, such as 9 minutes, before proceeding to step S150 to select the elevator that can most quickly arrive at the current storey. Thus, the user can save elevator waiting time. In the embodiment of the invention, steps S130 and S140 are optional procedures.

In n step S160, an elevator selection message is transmitted to the elevator control system by the mobile phone which has determined the state of the elevators according to the motion information and selected the elevator that can arrive at the current storey of the mobile phone most quickly. After receiving the elevator selection message, the control system sets the selected elevator to move to the current storey of the mobile phone and transmits an acknowledge signal (ACK) to the mobile phone. If the acknowledge signal transmitted by the control system is not received by the mobile phone, then the elevator selection message will be transmitted again until the acknowledge signal is received by the mobile phone.

Whereas the user may log in to the control system but forget to use the elevator latter on, the user may choose to set the reminder function in step S170. If the reminder function is set, then in step S180, whether the selected elevator has moved to a reminding storey corresponding to the current storey is determined by the mobile phone according to the motion information received at a fixed time interval. The reminding storey is such as two-storey different from the current storey of the mobile phone. If the elevator moves to the reminding storey, then in step S190, the mobile phone enters a reminder mode, in which the mobile phone shows a reminder message on the screen or sounds a voice/ring to remind the user. Thus, the user will not miss the elevator and does not need to wait for the next elevator.

Besides, the method for controlling the elevators of a multi-storey building by utilizing a mobile phone of the invention can be simplified. Referring to FIG. 3, a flowchart of another example of a method for controlling the elevators of a multi-storey building by utilizing a mobile phone according to a preferred embodiment of the invention is shown. In step S10, the current storey is detected by a mobile phone. In step S20, the elevator motion information is obtained via an intra-building broadcasting system. In step S30, the elevator motion information is displayed on the mobile phone screen. Thus, the user can instantly understand the motion information of the elevators via the mobile phone to the elevator waiting time.

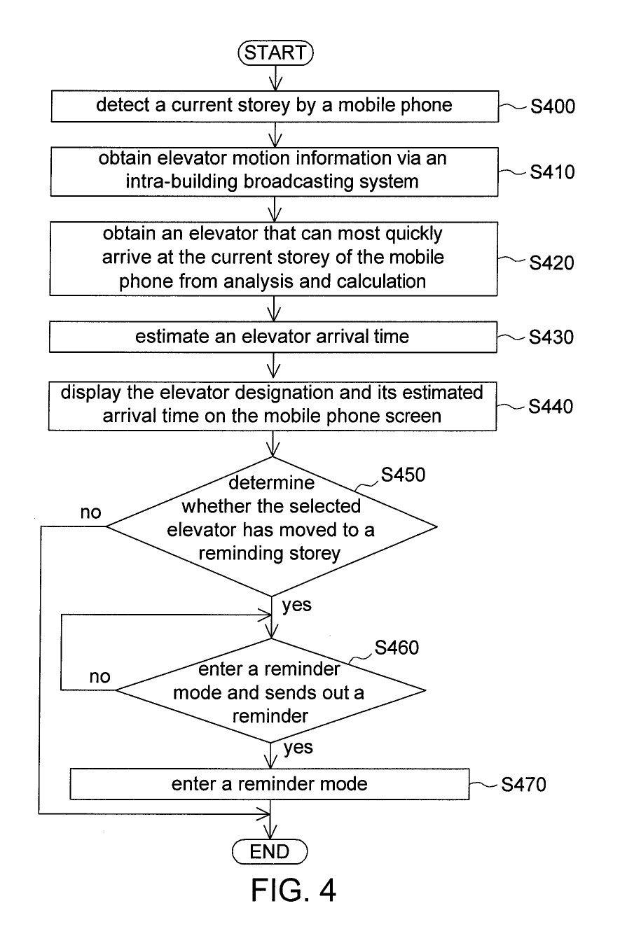

Referring to FIG. 4, a detailed flowchart of another example of a method for controlling the elevators of a multi-storey building by utilizing a mobile phone according to a preferred embodiment of the invention is shown. In step S400, the current storey is detected by a mobile phone, which recognizes the current storey of the mobile phone through such as a Wifi station. In step S410, the motion information of the elevators of a multi-storey building is obtained by the mobile phone via an intra-building broadcasting system. The elevator motion information includes information such as the current storey and the queue state of respective elevators, and the elevator motion information can be displayed on the mobile phone screen in drawings as indicated in FIG. 2.

In step S420, the motion information is analyzed by the mobile phone, and the elevator that can most quickly arrive at the current storey of the mobile phone is obtained from the calculation result of the motion information. After having determined which elevator can most quickly arrive at the current storey according to the calculation result of the motion information, in step S430, the elevator arrival time is estimated by the mobile phone according to the calculation result obtained in step S420. The estimation of the arrival time is calculated as follows: Suppose the elevator spends 10 seconds at each stop, and there are N stories to stop at, then the estimated arrival time is calculated as: 10×N seconds. Then, in step S440, the elevator designation and its estimated arrival time are displayed on the mobile phone screen.

Whereas the user may log in to the control system but forget to use the elevator latter on, the user may choose to set the reminder function in step S450. If the reminder function is set, then in step S460, whether the selected elevator has moved to a reminding storey corresponding to the current storey is determined by the mobile phone. The reminding storey is such as two-storey different from the current storey of the mobile phone (N−2). If the elevator moves to the reminding storey, then in step S470, the mobile phone enters a reminder mode. For example, the reminder can be sent out 10×(N−2) seconds after counting down the estimated arrival time, and the mobile phone shows a reminder message on the screen or sound a voice/ring to remind the user. Thus, the user will not miss the elevator and does not need to wait for the next elevator.

The method for controlling the elevators of a multi-storey building by utilizing a mobile phone disclosed in the above embodiments of the invention have many advantages exemplified below:

The method for controlling the elevators of a multi-storey building by utilizing a mobile phone enables the user to know the elevator motion information and log on to the elevator control system through the use of mobile phone to save the elevator waiting time. Furthermore, the reservation function and the reminder function provided in the method of the invention help the user to use the time more effectively, and largely reduce the elevator waiting time.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for controlling elevators of a multi-storey building by utilizing a mobile phone, comprising:
detecting a current storey by the mobile phone;
obtaining elevator motion information via an intra-building broadcasting system;
logging in to an elevator control system by the mobile phone;
selecting an elevator that can arrive at the current storey of the mobile phone according to the motion information; and
transmitting an elevator selection message to the elevator control system by the mobile phone for controlling the selected elevator to move to the current storey of the mobile phone.

2. The method according to claim 1, wherein the intra-building broadcasting system can be realized by a wireless local area network (wireless LAN), a general packet radio service (GPRS), a 3rd-generation (3G) or a 4th-generation (4G).

3. The method according to claim 1, wherein the elevator motion information is collected and updated by the elevator control system, which further broadcasts the elevator motion information via the intra-building broadcasting system at a fixed time interval.

4. The method according to claim 1, wherein the elevator motion information comprises information such as the current storey and the queue state of respective elevators.

5. The method according to claim 4, wherein the information relates to the current storey and the queue state of each elevator is illustrated in drawings and displayed on the mobile phone screen.

6. The method according to claim 1, further comprising:
setting a reminder function by the mobile phone which has transmitted the elevator selection message, wherein the reminder function determines whether the selected elevator moves to a reminding storey corresponding to the current storey of the mobile phone according to the motion information received at a fixed time interval; and
entering a reminder mode by the mobile phone when the elevator moves to the reminding storey.

7. The method according to claim 1, wherein after logging in to the elevator control system, the mobile phone further activates a reservation function and waits for a reservation time before selecting the elevator that can arrive at the current storey of the mobile phone most quickly according to the motion information.

8. The method according to claim 1, wherein after receiving the elevator selection message, the elevator control system sets the selected elevator to move to the current storey of the mobile phone and transmits an acknowledge signal to the mobile phone.

9. A method for displaying elevator state of multi-storey building by using a mobile phone, comprising:
detecting a current storey by the mobile phone;
obtaining elevator motion information via an intra-building broadcasting system; and
displaying the elevator motion information on the mobile phone screen.

10. The method according to claim 9, wherein the elevator motion information comprises information such as the current storey and the queue state of each elevator.

11. The method according to claim 10, wherein information such as the current storey and the queue state of each elevator is illustrated in drawings and displayed on the mobile phone screen.

12. The method according to claim 9, wherein the intra-building broadcasting system can be realized by a wireless local area network (wireless LAN), a general packet radio service (GPRS), a 3rd-generation (3G) or a 4th-generation (4G).

13. The method according to claim 9, further comprising:
analyzing the elevator motion information by the mobile phone;
obtain an elevator that can arrive at the current storey of the mobile phone from the calculation of the motion information;
estimating an elevator arrival time according to the above calculation result; and
displaying the estimated arrival time of the elevator that can arrive at the current storey on the mobile phone screen.

14. The method according to claim 13, further comprising:
setting a reminder function by the mobile phone which has transmitted the elevator selection message, wherein the reminder function determines whether the selected elevator moves to a reminding storey corresponding to the current storey of the mobile phone according to the motion information received at a fixed time interval; and
entering a reminder mode by the mobile phone when the elevator moves to the reminding storey.
